(19) United States
(12) Patent Application Publication
(10) Pub. No.: US 2015/0378542 A1
(43) Pub. Date: Dec. 31, 2015

(54) MANAGEMENT SYSTEM FOR COMPUTER SYSTEM

(71) Applicant: Hitachi, Ltd., Tokyo (JP)

(72) Inventors: Takeshi SAITO, Tokyo (JP); Tomoto WASHIO, Tokyo (JP); Kota SAITO, Tokyo (JP); Tsutomu FUJII, Kanagawa (JP); Daisuke NOGAMI, Tokyo (JP); Takao IKAWA, Chiba (JP)

(73) Assignee: Hitachi, Ltd., Tokyo (JP)

(21) Appl. No.: 14/761,097

(22) PCT Filed: Jul. 22, 2013
(86) PCT No.: PCT/JP2013/004460

§ 371 Date: Jul. 15, 2015

(51) Int. Cl. G06F 3/0484; G06F 3/0482

(52) U.S. Cl. CPC G06F 3/0484; G06F 3/0482; G06F 3/04845

(57) ABSTRACT

A management system is configured to display, on the basis of management information defining hierarchical relationships of a plurality of elements of a computer system, two or more element objects, which are GUI (Graphical User Interface) objects respectively corresponding to two or more elements belonging to the same hierarchical level, without displaying an element object of a lower-level element therewithin. The management system is configured to control, upon receiving a magnify indication conforming to a magnify operation for a first element object from among the two or more element objects, whether or not to display an element object of a lower-level element belonging to the first element inside the first element object in accordance with whether or not the zoom level reaches a prescribed level when the first element object is magnified in response to the magnify indication.

### TECHNICAL FIELD

The present invention generally relates to the management of a computer system, and more particularly to displaying information related to the computer system.

### BACKGROUND ART

For example, the technique disclosed in PTL 1 is known as a computer system-related information display. According to PTL 1, a topology of the computer system is displayed in a GUI (Graphical User Interface). Specifically, the GUI has a plurality of columns, and a component type to be displayed is stipulated for each column. An object representing each component is arranged in the corresponding column.

### CITATION LIST

### Patent Literature

[PTL 1]

US Patent Application Publication No. 2009/0249213

### SUMMARY OF INVENTION

### Technical Problem

As a management-targeted computer system grows in size, topology visibility decreases. For example, in a case where the management target is a large-scale computer system in which servers (hosts) numbering from the tens of thousands to the hundreds of thousands are arranged worldwide, it is impossible for a user to manage the entire image and to grasp the relationship between a component in which an error has occurred (for example, an apparatus or a component inside an apparatus) and another component.

This problem is not limited to cases in which the information displayed as computer system-related information is a computer system topology.

### Solution to Problem

A management system is configured to display, on the basis of management information defining hierarchical relationships of a plurality of elements of a computer system, two or more element objects, which are GUI (Graphical User Interface) objects respectively corresponding to two or more elements belonging to the same hierarchical level, without displaying an element object of a lower-level element therewithin. The management system is configured to control, upon receiving a magnify indication conforming to a magnify operation for a first element object from among the two or more element objects, whether or not to display an element object of a lower-level element belonging to the first element inside the first element object in accordance with whether or not the zoom level reaches a prescribed level when the first element object is magnified in response to the magnify indication.

### Advantageous Effects of Invention

The visibility of computer system-related information is good even when the computer system is large in scale.

### BRIEF DESCRIPTION OF DRAWINGS

FIG. 1 shows configurations of a computer system and a management system related to an embodiment.

FIG. 2 shows the configuration of a resource table 543.

FIG. 3 shows the configuration of a component table 544.

FIG. 4 shows an example of an initial display screen.

FIG. 5 shows an example of a display screen 400 subsequent to magnifying a resource box 601A shown in FIG. 4.

FIG. 6 shows an example of the display screen 400 subsequent to magnifying the resource box 602B shown in FIG. 5.

FIG. 7 shows an example of the display screen 400 subsequent to magnifying the resource box 602B shown in FIG. 6.

FIG. 8 shows a first example of the display screen 400 subsequent to a shrink operation with respect to the leaf resource box 603A shown in FIG. 7.

FIG. 9 shows a second example of the display screen 400 subsequent to a shrink operation with respect to the leaf resource box 603A shown in FIG. 7.

FIG. 10 shows an example of the display screen 400 subsequent to a specify operation with respect to the leaf resource box 603A shown in FIG. 7.

FIG. 11 is an example of a display range of the display screen 400 of FIG. 10 after scrolling horizontally to the right.

FIG. 12 shows an example of a component type box “Volume” 701B in a case where a magnify operation (or specify operation) has been performed with respect to the component type box “Volume” 701B in the display screen 400 of either FIG. 10 or FIG. 11.

FIG. 13 shows the flow of processing for the initial rendering of a box.

FIG. 14 shows the flow of a magnifying process.

FIG. 15 shows the flow of processing for rendering a child resource.

FIG. 16 shows the flow of processing for rendering a box.

FIG. 17 shows the flow of a shrink process.

FIG. 18 shows the flow of processing for hiding a child resource.

FIG. 19 shows a portion of the flow of processing for rendering a capacity box.

FIG. 20 shows the remainder of the flow of processing for rendering the capacity box.

FIG. 21 shows the flow of processing for developing a leaf resource component.

FIG. 22 shows a portion of the flow of processing for rendering a storage box.

FIG. 23 shows the remainder of the flow of processing for rendering the storage box.

FIG. 24 shows the flow of processing for rendering connecting lines to component type boxes.

### DESCRIPTION OF EMBODIMENT

The embodiment will be explained below.

In the following explanation, information may be explained using the expression “xxx table”, but the information may also be expressed using any other data structure. To show that the information is not dependent on the data structure, “xxx table” can be called “xxx information”.

Also, in the following explanation, there may be cases where processing is explained having “program” as the subject, but since the stipulated processing is performed in accordance with a program being executed by a processor (for example, a CPU (Central Processing Unit)) while using a storage device (for example, a memory) and/or a communication interface device (for example, a communication port) as appropriate, the subject of the processing may also be the processor. A process, which is explained using the program as the subject, may be regarded as a process performed by a processor or by a management system having this processor (for example, a computer for display use (for example, a client) or a computer for management use (for example, a server)). Furthermore, the processor may be the CPU itself, or may include a hardware circuit that carries out either part or all of the processing performed by the processor. A program may be installed in respective controllers from a program source. The program source, for example, may be either a program delivery server or a storage medium. The program delivery server may be a computer for management use.

In the following explanation, a name or ID is used as identification information for a variety of targets (for example, resources and components). But these names and IDs may be interchangeable with one another, and other types of identification information may be used either in place of or in addition to at least one thereof.

The management system may be configured using one or more computers. Specifically, for example, in a case where a management computer is configured to display information (specifically, a case in which the management computer is configured to display information on its own display device, or the management computer is configured to send the information to be displayed to a remote computer for display use), the management computer is the management system. Also, for example, in a case where functions identical to those of the management computer are realized using a plurality of computers, the plurality of computers (may include the computer for display use when the computer for display use performs the display) is the management system. In this embodiment, a management server 557 is the management computer, and a management client 555 is the computer for display use.

Furthermore, in the following explanation, an operation that a user (for example, an administrator) performs using an input device with respect to a GUI (Graphical User Interface) screen serving as a management screen of the computer system will be referred to as a “user operation”. Generally speaking, the input device used in a user operation will be either a pointing device or a touch screen. User operations, for example, may include a “specify operation”, a “magnify operation”, and a “shrink operation” for a GUI object (an object being displayed in the GUI). A GUI object specify operation, for example, may involve using a pointing device to hover the pointing device (for example, mouse) cursor over the GUI object or touching a finger to a touch screen in order to click on the GUI object. An ordinary magnify operation, for example, rolling the mouse wheel forward while the cursor is hovering over the GUI object, or pinching in over the GUI object on a multi-touch screen, may be used as a GUI object magnify operation. Similarly, an ordinary shrink operation, for example, rolling the mouse wheel backward while the cursor is hovering over the GUI object, or pinching out over the GUI object on a multi-touch screen, may be used as a GUI object shrink operation.

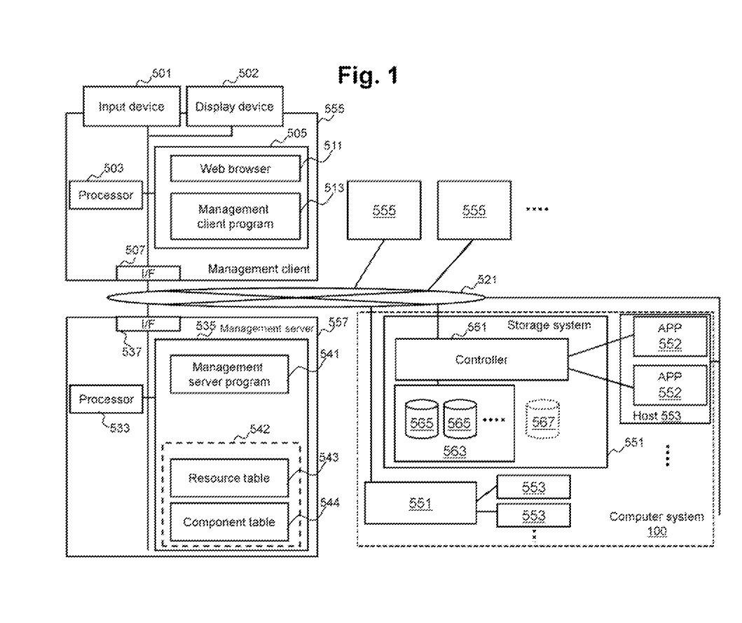

FIG. 1 shows the configurations of a computer system and a management system related to the embodiment.

The computer system 100 includes one or more hosts 553, and one or more storage systems 551 coupled to the one or more hosts 553. A host 553 is coupled to a storage system 551, for example, via a communication network (for example, a SAN (Storage Area Network) or a LAN (Local Area Network)).

The storage system 551 comprises a physical storage device group 563, and a controller 561 coupled to the physical storage device group 563.

The physical storage device group 563 comprises one or more PGs (Parity Groups). The PG may also be called a RAID (Redundant Array of Independent (or Inexpensive) Disks) group. The PG is configured using a plurality of physical storage devices, and stores data in accordance with a prescribed RAID level. The physical storage device, for example, is a HDD (Hard Disk Drive) or a SSD (Solid State Drive).

The storage system 551 comprises a plurality of logical volumes. The logical volumes may comprise substantial logical volumes (real volumes) 565 based on the PG, and virtual logical volumes (virtual volumes) 567 conforming to either thin provisioning or storage virtualization technology. One storage system 551 does not necessarily have to comprise a plurality of types of logical volumes. For example, a storage system 551 may comprise only real volumes 565 as logical volumes. A storage area is allocated from a pool to a virtual volume that conforms to thin provisioning. A pool is a storage area group based on one or more physical storage devices (for example, a RG), and, for example, may be a set of one or more logical volumes. Instead of a pool having storage areas that are allocated to a virtual volume conforming to thin provisioning, the pool may be one in which a difference between an original logical volume and a snapshot thereof is stored.

The controller 561 comprises a plurality of devices, for example, a port, a MPB (a blade (circuit board) comprising one or a plurality of microprocessors (MP)), and a cache memory. For example, the port is configured to receive an I/O (Input/Output) command (either a write command or a read command) from the host 553, and the MP of the MPB is configured to control the data I/O in accordance with the I/O command. Specifically, for example, the MP is configured to identify the I/O-destination logical volume from the received I/O command, and to perform data I/O with respect to the identified logical volume. Data to undergo I/O to/from the logical volume is temporarily stored in the cache memory.

The host 553 may be either a physical computer or a virtual computer. One or more application programs (APP) 552 are executed on the host 553. An I/O command specifying a logical volume is sent from the host 553 to the storage system 551 as a result of an APP 552 being executed.

As described hereinabove, the computer system 100 has a plurality of elements arranged in a hierarchical manner. The plurality of elements, specifically, is the APP 552, the host 553, the storage system 551, the controller 561, the port, the MPB, the cache memory, the logical volume, and the PG. In this embodiment, of the plurality of elements, an element that is at a higher level than a prescribed boundary is referred to as a “resource”, and an element that is at a lower level than the prescribed boundary is referred to as a “component” for the sake of convenience. In this embodiment, a resource is a host 553-side element, and a component is a storage system 551-side element. Grouping together a plurality of elements in the same hierarchical level (a plurality of elements that share a parent element in common) makes it possible to define an element that is at a higher level than the elements in the same hierarchical level. That is, an “element” may be a substantial element like an APP or a logical volume, or may be a virtual element, which is a group of a plurality of substantial elements. Also, a “parent element” of an element is associated with the element, and is an element of a hierarchical level that is one higher than that of the element. An element that is associated with an element and is at a hierarchical level that is one lower than that of the element can be referred to as a “child element”.

The management system includes a management server 557 and one or more management clients 555 coupled to the management server 557. A management client 555 is coupled to the management server 557 via a communication network (for example, a LAN, a WAN (World Area Network), or the internet) 521.

The management client 555 comprises an input device 501, a display device 502, a storage device (for example, a memory) 505, a communication interface device (hereinafter, I/F) 507, and a processor (for example, a CPU (Central Processing Unit)) 503 coupled thereto. The input device 501, for example, is a pointing device or a keyboard. The display device 502, for example, is a device comprising a physical screen on which information is displayed. A touch screen, which integrates the input device 501 and the display device 502, may be used. The I/F 507 is connected to the communication network 521, and the management client 555 is able to communicate with the management server 557 via the I/F 507. A network for coupling the communication network 521, and the host 553 and storage system 551 may be shared either partially or wholly.

The storage device 505, for example, comprises at least a main storage device (typically a memory) from among the main storage device and an auxiliary storage device. The storage device 505 can store a computer program executed by the processor 503, and information used in the processor 503. Specifically, for example, the storage device 505 is configured to store a Web browser 511 and a management client program 513. The management client program 513 may be a RIA (Rich Internet Application). Specifically, for example, the management client program is a program file, and may be downloaded from the management server 557 (or another computer) and stored in the storage device 505.

The management server 557 comprises a storage device 535, an I/F 537, and a processor (for example, a CPU (Central Processing Unit)) 533 coupled thereto. The I/F 537 is connected to the communication network 521, and the management server 557 is able to communicate with the management client 555 via the I/F 537. The management server 557 can receive an indication conforming to a user operation and render a GUI object in a layout area via the I/F 537. Thus, the I/F 537 is an example of an I/O interface device. Furthermore, as used here, a “layout area” is an area in which a GUI object can be rendered (arranged). Either part or all of the range of the layout area is the display range of a frame (for example, a window) displayed by the Web browser 511 (or the management client program 513). A display image (including a GUI object) inside the above-mentioned frame of the layout area in which the GUI object has been rendered can be referred to as a display screen (GUI screen). Of the objects rendered in the layout area, an object that overlaps with the display range is displayed on the physical screen of the display device 502. Thus, rendering an object in the layout area is essentially an example of displaying the object.

The storage device 535, for example, comprises at least a main storage device (typically a memory) from among the main storage device and an auxiliary storage device. The storage device 535 is able to store a computer program executed by the processor 533 and information used in the processor 533. Specifically, for example, the storage device 535 is configured to store a management server program 541 and a management table 542. The management table 542 is for defining the hierarchical relationship of the plurality of elements of the computer system, and, for example, includes a resource table 543 and a component table 544. The management server program 541 is configured to receive an indication conforming to a user operation from the management client 555 and to send information that has been rendered in the layout area to the management client 555. The resource table 543 comprises information related to a plurality of resources of the computer system. 100. The component table 544 comprises information related to a plurality of components of the computer system 100.

A GUI display corresponding to a user operation is realized by the cooperative processing of the management server program 541, the Web browser 511 (or the client RIA execution environment), and the management client program 513. The following are examples of such cooperation. In this embodiment, (Cooperation Example 2) is used. (Cooperation Example 1) The management server program 541 is configured to send at least part of the information in tables 543 and 544 to the Web browser 511 (or the management client program 513), and the Web browser 511 (or the management client program 513) is configured to store the information in the storage device 505 as temporary information. The Web browser 511 (or the management client program 513) is configured to render a GUI object in the layout area (for example, newly renders, magnifies, or shrinks a GUI object) on the basis of an indication conforming to a user operation and the temporary information. (Cooperation Example 2) The management server program 541 is configured to receive an indication conforming to a user operation with respect to the display screen from the Web browser 511 (or the management client program 513), to create information for displaying a GUI object on the basis of the indication and table 543 or 544, and to send the information for display use. The Web browser 511 (or the management client program 513) is configured to receive the information for display use, and to render a GUI object in the layout area in accordance with the information for display use. That is, put plainly, the management server program 541 is configured to render the GUI object in the layout area. The Web browser 511 (or the management client program 513), upon being subjected to a user operation related to the GUI, is configured to send an indication conforming to the user operation to the management server program 541.

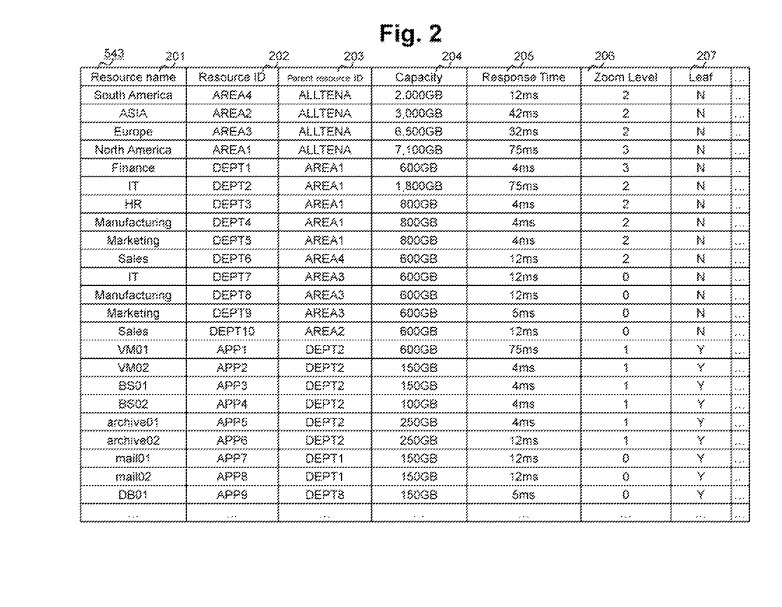

FIG. 2 shows the configuration of the resource table 543.

The resource table 543 is configured to define a tree-shaped hierarchical relationship of the plurality of resources. The resource table 543 comprises the following information for each resource, for example, a resource name ID 201, which is the name of a resource, a resource ID 202, which is the ID of the resource, a parent resource ID 203, which is the ID of a parent resource (a resource associated with the resource and in one hierarchical level thereabove), a capacity 204, which is the total storage capacity of the logical volume provided to the resource, a response time 205, which is the response time (measured value) of the resource, a zoom level 206, which is the zoom level (value) of a resource object (one GUI object) representing the resource, and a leaf 207 showing whether or not the resource is a leaf resource (a terminal resource). Another type of information may be registered in the resource table 543 for each resource either in place of or in addition to at least one of the pieces of information 201 through 207. The hierarchical relationship of resources is clear from the resource ID 202 and the parent resource ID 203. Also, the zoom level (the zoom level in the GUI) of a resource object of the resource is clear from the zoom level 206 of the resource. In this embodiment, the zoom level is expressed using an integer of equal to or larger than 0, but may be defined using another method. A resource box of a resource corresponding to zoom level “0” is hidden (for example, does not exist in the layout area).

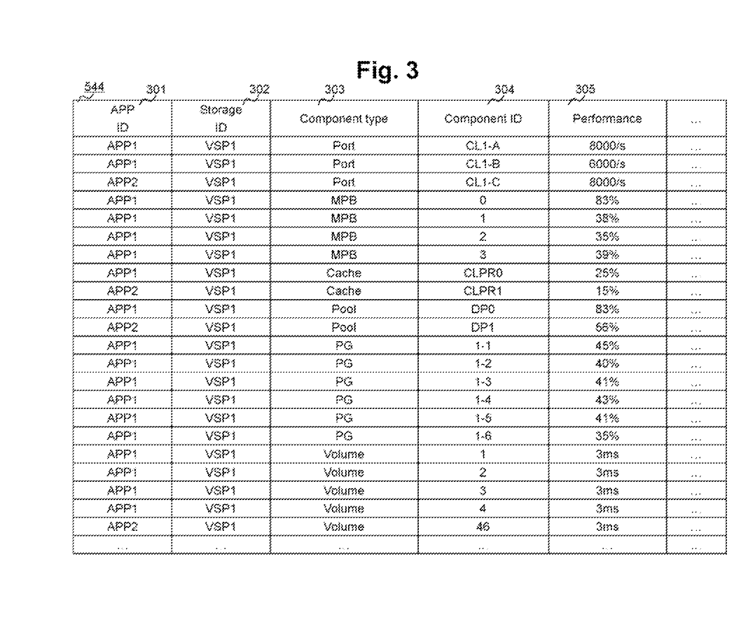

FIG. 3 shows the configuration of the component table 544.

The component table 544 is configured to define the tree-shaped hierarchical relationship of the plurality of components, and to express the relationship between a component and a resource. The component table 544 comprises the following information for each component, for example, an APP ID 301, which is the ID of a leaf resource (APP) with which a component is associated, a storage ID 302, which is the ID of the storage system comprising the component, a component type 303 expressing the type of the component, a component ID 304, which is the ID of the component, and a performance 305 expressing the performance (measured value) demonstrated by the component. Another type of information may be registered in the component table 544 for each component either in place of or in addition to at least one of the pieces of information 301 through 305. The hierarchical relationship of a component, for example, may be identified from the component type 303 and a prescribed rule (for example, a rule expressing the relationship between a component type and a component ID type), but the parent component (a component one hierarchical level above the component) may be defined for each component as in the resource table 543. A group configured using a plurality of different component types may also be defined in the component table 544.

The preceding has been examples of tables 543 and 544. The definitions of the hierarchical relationships of elements given as examples in FIGS. 2 and 3 include a definition of the relationship between an element and a parent element (the element one hierarchical level above the element), and a definition that uses the type of the element, but a definition conforming to another method may be used. For example, in the resource table 543, the hierarchical relationship of a resource maybe defined on the basis of the resource type rather than the relationship between the resource and the parent resource. Also, tables 543 and 544 may be integrated.

The management server program 541 is configured to control the display (rendering) of a resource object (a GUI object representing the resource) on the basis of the resource table 543, and to control the display (rendering) of a component object (a GUI object representing the component) on the basis of the component table 544.

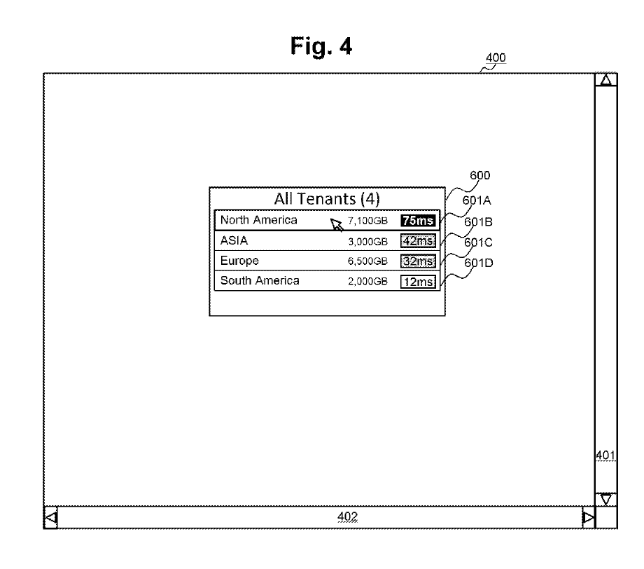

An overview of the display control performed in this embodiment will be explained below by referring to FIGS. 4 through 12. In the following examples, the resource object and the component object are both square, and as such, the resource object and the component object are respectively referred to as a “resource box” and a “component box”.

FIG. 4 shows an example of an initial display screen.

The “initial display screen” is the display screen 400 in a case where a process for the initial rendering of a box, which will be described further below, has been performed. Also, as used here, the display screen 400 is one part of a screen displayed by the Web browser 511 (or the management client program 513). The display screen 400 comprises a slider bar 401 for vertical scrolling, and a slider bar 402 for horizontal scrolling. Information displayed on the display screen 400 is the information, from among the information rendered in the layout area (for example, a GUI object, text, or the like), that overlaps with the display range.

The management server program 541 is configured to render a root resource box 600 representing the root resource “All Tenants”, and, in addition, to render, inside the root box 600, a plurality of resource boxes 601A through 601D respectively corresponding to a plurality of (or one) child resource of the root resource. The child resource of a target resource (in other words, a resource that regards the target resource as a parent resource) is identified on the basis of the resource table 543. The resource boxes 601A through 601D are arrayed in the vertical direction (in the Y direction in the case of XY coordinates). As used here, the “root resource” is the only resource constituting the highest level. A concept such as root resource does not have to exist, in which case, the plurality of resources belonging to the second hierarchical level in this embodiment may be the highest level of resources. Furthermore, the “child resource” of a resource is associated with the resource and is one level lower than the resource. By contrast, the “lower-level resource” of a resource is all of the lower-level resources associated with the resource. Thus, the “lower-level resource” of a resource includes the child resource, and a resource that is at a lower level than the child resource.

In this embodiment, a resource box representing a resource other than a leaf resource is either magnified or shrunk by the management server program 541 in accordance with either a magnify operation or a shrink operation related to this resource box. Magnifying or shrinking the resource box either raises or lowers the zoom level of the resource box, that is, changes the zoom level of the resource box. In the processing for initially rendering a box, the zoom levels of the boxes 600 and 601A through 601D may be at the minimum level.

The management server program 541 is configured to display, in the root box 600, a value “(4)” representing the number of child resources in the root resource “All Tenants”. That is, in this embodiment, a numeral in parentheses written beside a word representing the name (or ID) of a resource indicates the number of child resources.

The management server program 541 is configured to display a resource name 201 and summary information for each resource box 601A through 601D on the basis of the resource table 543. Resource box 601A will be given as an example. The resource name “North America” and summary information corresponding to the resource box 601A is displayed in the box 601A. The summary information displayed is the capacity 204 of the resource “North America”, and the response time 205 of the resource “North America”. The capacity 204 of the resource “North America” may be the total of the capacities 204 of the child resources of the resource “North America”. The response time 205 of the resource “North America” may be a value (for example, a maximum value (or an average value)) based on the response times 205 of the child resources of the resource “North America”. The display mode of the response time 205 for the resource “North America” is the mode corresponding to a status (response status) conforming to this response time 205. In the example shown in the drawing, since the response time 205 for the resource “North America” exceeds a first threshold, the response time 205 for the resource “North America” is displayed using a display mode that signifies a warning. The response times 205 of the resources respectively corresponding to boxes 601B and 601C are less than the first threshold but equal to or larger than a second threshold (the first threshold>the second threshold), and as such, the response times 205 thereof are displayed using a display mode that signifies caution. The response time 205 of the resource corresponding to box 601D is less than the second threshold, and as such, the response time 205 thereof is displayed using a display mode that signifies normal.

The user can clearly ascertain from the display screen 400 in FIG. 4 that the storage capacity provided to the resource “North America” is 7100 GB, and, in addition, that the child resources of the resource “North America” include a child resource having a response time of 75 ms (milliseconds).

It will be assumed that a magnify operation was performed by the user while the cursor was over the user-desired resource box 601A. In accordance with this, the management server program 541 is configured to receive a magnify indication conforming to the manipulated variable of the magnify operation (for example, the angle of rotation of the mouse wheel), and to magnify the resource box 601A in accordance with the manipulated variable.

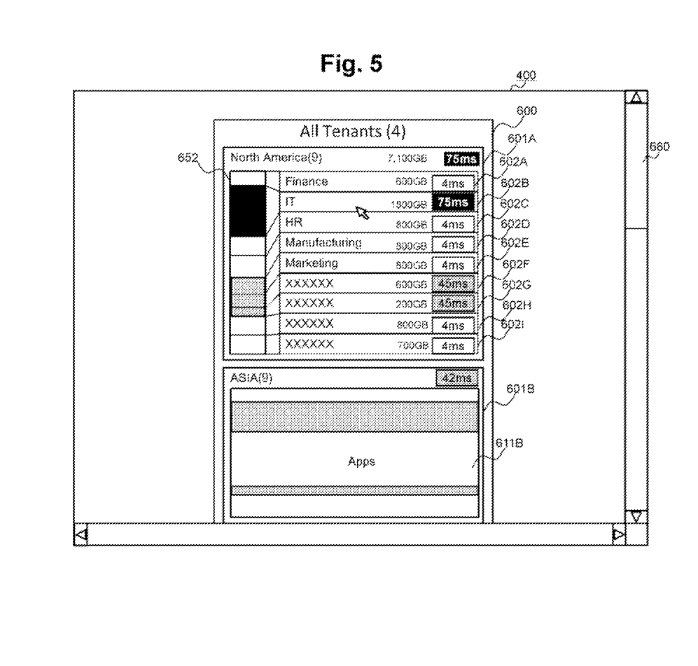

FIG. 5 shows an example of the display screen 400 subsequent to magnifying the resource box 601A shown in FIG. 4.

The management server program 541 is configured to magnify the resource box 601A in accordance with the manipulated variable of the magnify operation. In this embodiment, the magnification of a resource box is not performed so as to maintain the aspect ratio of the resource box, but rather is performed such that the height (vertical length) of the resource box is magnified more than the width (horizontal length) of the resource box. Specifically, the magnification of the resource box may be such that only the height of the resource box is magnified. Similarly, the shrinking of a resource box is not performed so as to maintain the aspect ratio of the resource box, but rather is performed such that the height of the resource box is shrunk more than the width of the resource box. Specifically, the shrinking of the resource box may be such that only the height of the resource box is shrunk. The management server program 541 is configured to update the zoom level 206 (the value in the resource table 543) corresponding to the resource box each time the resource box is magnified or shrunk (each time the zoom level changes). In a case where magnified resource boxes 601A through 601D do not fit into the display range as shown in FIG. 5, the user can relatively vertically scroll the display range by operating a slider 680 in order to see all of the resource boxes 601A through 601D. Boxes (for example, 601C and 601D) that are to be rendered in the layout area in a location other than the display range (and the vicinity thereof) need not be rendered. The rendering of such boxes (for example, 601C and 601D) maybe performed dynamically in accordance with the display range scrolling.

The management server program 541 is configured to perform processing (1) and (2) below when magnifying the resource box 601A.

(1) When raising the zoom level of the resource box 601A targeted for a magnify operation, the management server program 541 is configured to determine whether or not the post-change zoom level reaches a prescribed level. When the result of this determination is true, the management server program 541 is configured to perform the following processing (1-1) and (1-2) in line with magnifying the resource box 601A.

(1-1) The management server program 541 is configured to identify the child resources of the magnify operation-target resource “North America” from the resource table 543 to display resource objects 602A through 602I of the identified child resources lined up vertically inside the magnified resource box 601A. The initial zoom level of each of the resource objects 602A through 602I may be the minimum level. The resource names 201 and summary information (for example, the capacities 204 and the response times 205) of the corresponding resources are displayed in each of the resource objects 602A through 602I the same as in the resource objects 601A through 601D.

(1-2) Furthermore, the management server program 541 is configured to display a capacity box 652 inside the magnified resource box 601A. The capacity box 652 is an example of an object that is long in the array direction (that is, the vertical direction) of the resource objects 602A through 602I. The capacity box 652 is displayed on one side (for example, the left) and in the vicinity of (for example, adjacent to) the column of resource objects 602A through 602I. The height (length) of the capacity box 652 may be the same as the height of the column of resource objects 602A through 602I. For example, the Y coordinates on the left side (and right side) at both ends of the capacity box 652 may be the same as the Y coordinates of the upper left corner (or upper right corner) of the topmost resource object 602A, and the Y coordinate of the lower left corner (or lower right corner) of the bottommost resource object 602I. The capacity box 652 may be partitioned into a plurality of areas respectively corresponding to the plurality of resource objects 602A through 602I. The height (vertical length) of one area is a length corresponding to the capacity 204 of the resource corresponding to this area. Specifically, for example, the height of the area corresponding to the resource “IT” may be the product obtained by multiplying the ratio of the capacity 204 of the resource “IT” to the capacity 204 of the resource “North America” (the total of the plurality of capacities 204 corresponding to all the resources that have the resource “North America” as the parent resource) by the height of the capacity box 652. The display mode for an area inside the capacity box 652 may be a display mode (for example, warning, caution, or normal) conforming to a status (capacity status) based on the capacity 204 of the resource corresponding to this area. For example, a used capacity is managed in the resource table 543 with respect to the capacity 204, and the capacity status may be defined in accordance with the size of the ratio of the used capacity to the capacity 204. Lines showing the connection between an area and a resource box may be rendered between an area and the resource box corresponding thereto for each area of the capacity box 652.

(2) The management server program 541, in line with magnifying the magnify operation-target resource box 601A, is configured to also magnify the resource boxes 601B through 601D of the resource for which the parent resource is the same as that of the resource “North America” (in FIG. 5, only box 601B of the boxes 601B through 601D is shown in the drawing). Specifically, the management server program 541 is configured to raise the zoom levels of the resource boxes 601B through 601D so as to be the same as the zoom level of the magnify operation-target resource box 601A. However, none of resource boxes 601B through 601D is the magnify operation target. Resource box 601B will be given as an example. The management server program 541 is configured not to render a resource box of a child resource of the resource corresponding to the resource box 601B inside the magnified resource box 601B even when the zoom level of the resource box not targeted for the magnify operation 601B has reached a prescribed level. A summary box 611B is rendered inside the resource box not targeted for the magnify operation 601B. The summary box 611B comprises a plurality of areas respectively corresponding to a plurality of child resources of the resource “ASIA”, and the display mode for each area corresponds to the response status (or capacity status) of the child resource corresponding to this area.

For a plurality of resources having the same parent resource, the maximum level of the zoom level for a resource box not targeted for the magnify operation may be less than a prescribed level, for example, a level one lower than the prescribed level. This makes it possible for the resource box not targeted for the magnify operation to avoid reaching the prescribed level.

It will be assumed that a magnify operation has been performed by the user while the cursor was over the resource box 602B. In accordance with this, the management server program 541 is configured to magnify the resource box 602B in accordance with the manipulated variable of this magnify operation, and, in addition, to magnify the resource box 601A (the resource box of the parent resource) enclosing this resource box 602B.

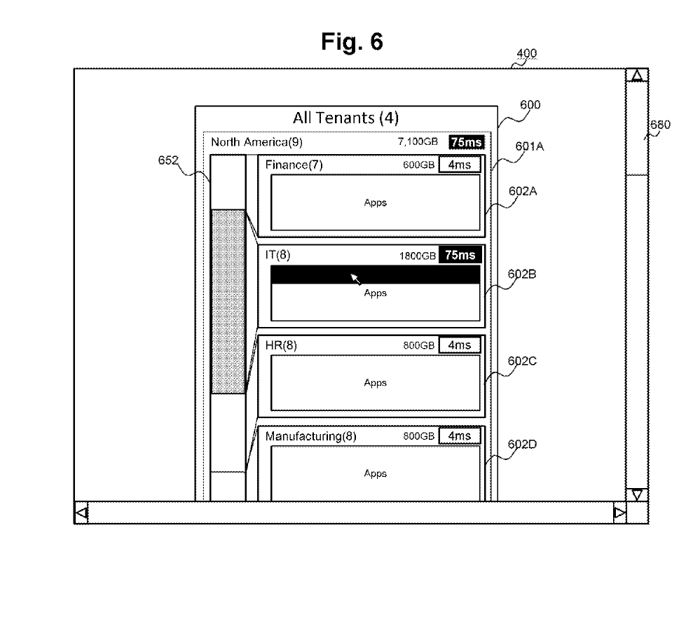

FIG. 6 shows an example of the display screen 400 subsequent to magnifying the resource box 602B shown in FIG. 5.

The management server program 541 is configured to perform processing like that described in (1) and (2) above when magnifying one or another of the resource boxes targeted for a magnify operation such as resource box 602B. Resource box 602B will be given as an example. In (1), when the post-magnify zoom level of the magnify operation-target resource box 602B has reached a prescribed level, the management server program 541 is configured to display a resource box of a child resource of the “IT” resource inside the resource box 602B, and, in addition, to display the capacity box. In (2), the management server program 541 is configured to raise the respective zoom levels of resource boxes 602A and 602C through 602I of the other resources having the same parent resource as the resource “IT” to the same zoom level as the magnify operation-target resource box 602B. Regarding (1) and (2), the management server program 541 is configured to heighten (lengthen) the height (length) of the capacity box 652 of the parent resource “North America” in accordance with the magnification of the resource boxes 602A through 602I.

An example of a display result conforming to this rule is shown in FIG. 6. According to FIG. 6, since the zoom level of the magnify operation-target resource box 602B is less than the prescribed level, a child resource object is not represented inside the box 602B. The zoom levels of the other resource boxes 602A and 602C through 602I are the same as the zoom level of the post-magnify resource box 602B. In addition, the height of the capacity box 652 is magnified to a height that covers the post-magnify resource boxes 602A through 602I (for example, the height from the Y coordinate at the upper left corner of the post-magnify resource box 602A to the Y coordinate at the lower left corner of the post-magnify resource box 602I).

It will be assumed that another magnify operation has been performed by the user while the cursor was over the user-desired resource box 602B.

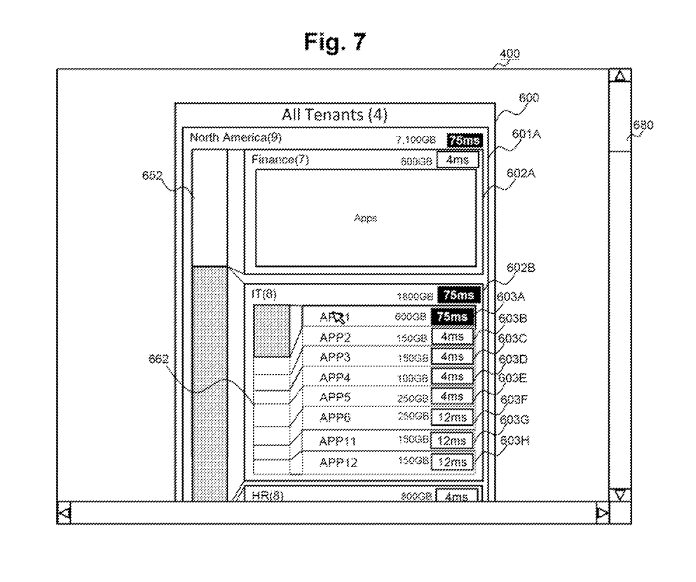

FIG. 7 shows an example of the display screen 400 subsequent to magnifying the resource box 602B shown in FIG. 6.

Since the post-magnify zoom level of the resource box 602B has reached the prescribed level, the management server program 541 is configured to display resource boxes 603A through 603H corresponding to the child resource “APP1” and so forth of the resource “IT” inside the resource box 602B, and, in addition, to display a capacity box 662 of the same height as the height of these resource boxes 603A through 603H inside the resource box 602B. Since the post-magnify zoom level of the resource box 602B has reached the prescribed level, the other resource boxes 602A and 602C through 602I need not be magnified.

The capacity box 662 is partitioned into eight areas, which are lined up vertically and correspond to the child resources “APP1” through “APP6”, and “APP11” and “APP12” of the resource “IT”. For example, the height of the resource “APP1” area, as was described hereinabove, is the product of the ratio of the capacity 204 of the resource “APP1” to the capacity 204 of the parent resource “IT” multiplied by the height of the capacity box 662.

According to the resource table 543, the resources “APP1” through “APP6”, and “APP11” and “APP12” here are each leaf resources. The management server program 541, in a case where a magnify operation has been performed by the user, is configured to determine whether or not the resource being targeted by the magnify operation is a leaf resource, and when the result of the determination is true, not to magnify (shrink) the magnify operation-target resource box. That is, in this embodiment, the resource box zoom level for a leaf resource is fixed.

It will be assumed that a shrink operation has been performed by the user with respect to the display screen 400 shown in FIG. 7.

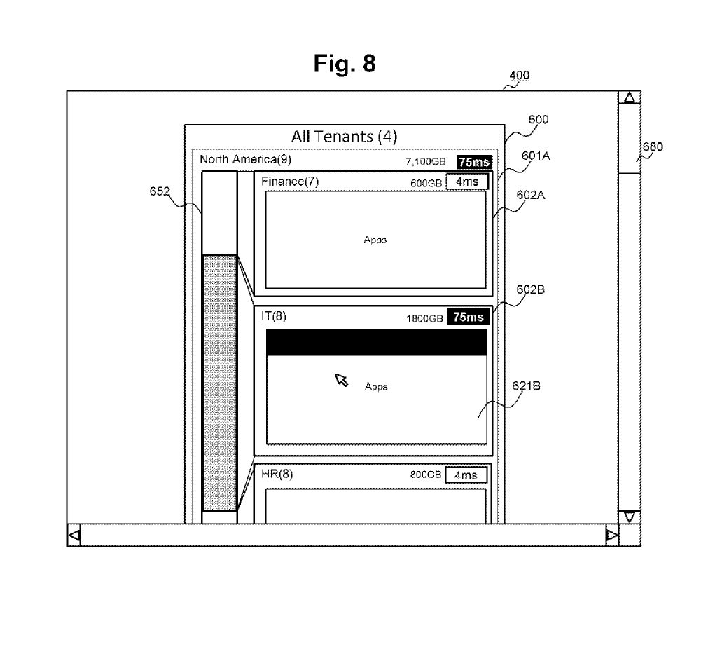

In a case where the target of the shrink operation is the resource box 602B inside which are the resource boxes of child resources (specifically, a case in which the shrink operation was performed while the cursor was over the resource box 602B), as shown in FIG. 8, the management server program 541 is configured not to change the zoom levels of resource box 602B and the other resource boxes 602A and so forth on the same hierarchical level, and not to display the resource boxes 603A and so forth and the capacity box 662 from the resource box 602B. Specifically, the display mode of the resource box 602B is the same as that of the other resource boxes 602A and so forth. That is, a summary box 621B is rendered in the resource box 602B in place of the resource boxes 603A and so forth and the capacity box 662.

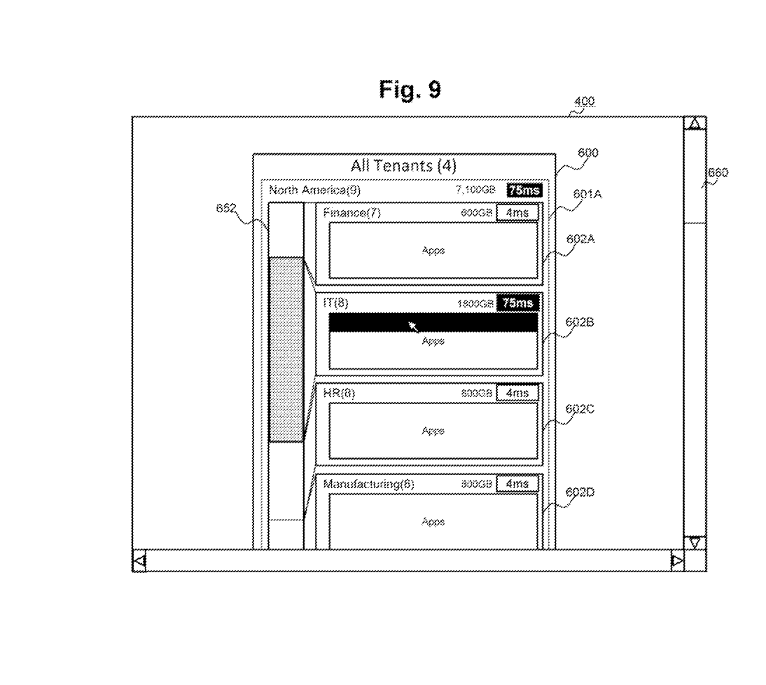

In a case where the target of a shrink operation is a resource box other than resource box 602B inside which is the resource box of a child resource (for example, 602A), as shown in FIG. 9, the management server program 541 is configured to shrink each of the resource boxes 602A through 602I in accordance with the manipulated variable of the shrink operation (lowers the zoom level of each of the resource boxes 602A through 602I). In line with this, the management server program 541 is configured to also shrink the resource box 601A surrounding the resource boxes 602A through 602I, and to also shrink each of the resource boxes 601B through 601D on the same hierarchical level as the resource box 601A. That is, the zoom levels of each of the post-shrink resource boxes 601A through 601D may be the same.

Now then, it will be assumed that a specify operation has been performed by the user with respect to the resource box of a leaf resource related to the display screen 400 shown in FIG. 7. The specify operation, as was explained hereinabove, is a click, for example. In accordance with this, the management server program 541 is configured to identify, from the component table 544, a plurality of components associated with the specify operation-target leaf resource, and to line up horizontally a plurality of component boxes corresponding to the identified plurality of components.

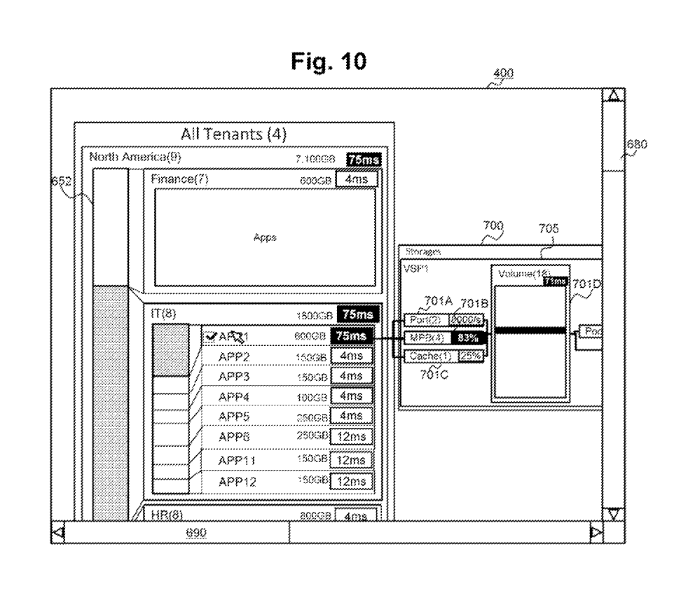

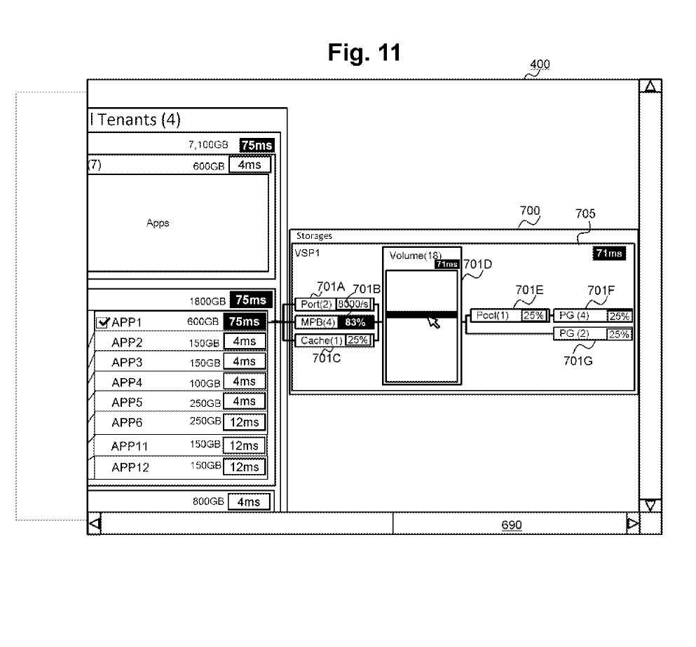

FIG. 10 shows an example of the display screen 400 subsequent to a specify operation having been performed with respect to the leaf resource box 603A shown in FIG. 7. FIG. 11 is an example of the display range of the display screen 400 of FIG. 10 after scrolling horizontally to the right. The horizontal scrolling, for example, is performed by operating a slider 690 for horizontal scrolling.

The management server program 541, in a case where a specify operation has been performed with respect to the leaf resource “APP1”, is configured to identify, from the component table 544, a component associated with the leaf resource “APP1”. The management server program 541 is configured to render a storage box 700. The storage box is an example of a GUI object in which is rendered one or more storage system boxes respectively corresponding to one or more storage systems comprising the component associated with the specify operation-target leaf resource. A storage system box corresponds to one storage system, and the storage box corresponds to one or more storage systems. According to FIGS. 10 and 11, the storage system comprising the component associated with the leaf resource “APP1” targeted for the specify operation is identified by the management server program 541 as being one storage system “VSP1”, and one storage system box 705 is rendered in the storage box 700. The storage box 700 is rendered on the right side of the leaf resource box 603A (the side opposite the side where the capacity box 662 exists).

The management server program 541 is configured to render a component box corresponding to the identified component in the storage system box 705 corresponding to the storage system comprising this component. Component boxes (701A, 701D, 701E, 701F) are lined up horizontally on the basis of the hierarchical relationship (type) of the component, having the leaf resource box 603A as the highest level. Lines representing hierarchical relationships (coupling relationships) are rendered between the component boxes lined up horizontally. That is, the component boxes of components having a hierarchical relationship are connected to one another by a line.

The initial component box may be a component type box covering a plurality of components of the same type (same hierarchical level). That is, one component box may be rendered even though there is a plurality of the same type component. According to the examples in FIGS. 10 and 11, although two components “CL1-A” and “CL1-B” exist for the component type “Port” (refer to FIG. 3), one component type box 701A may be rendered, and, in addition, a notation “Port (2)” signifying that two components exist for the component type “Port” may be made in this component type box 701A. That is, in this embodiment, a numeral in parentheses written beside the word representing the type of the component indicates the number of components corresponding to this type. Furthermore, two component boxes corresponding to the two components “CL1-A” and “CL1-B” for the component type “Port” may be rendered in the component type box 701A right from the start. Also, a plurality of component type boxes 701F and 701G of the same type (same hierarchical level) are lined up vertically.

The component type boxes 701A through 701C of a plurality of different types (hierarchical levels) are lined up vertically even though the types are different because the component types belong to a prescribed group. The prescribed group, for example, may be a group of types defined with respect to the data flow without any particular need to be cognizant of the hierarchical relationships therebetween. According to the examples in FIGS. 10 and 11, the plurality of component type boxes 701A through 701C corresponding to the component types “Port”, “MPB”, and “Cache” are lined up vertically. This is because the user is normally not cognizant of the relationships between the port, the MPB, and the cache memory at the time of analysis. A group lined up vertically may be defined in the component table 544, may be defined using information (for example, a definition file) that differs from the component table 544, or may be defined using a management server program 541 description.

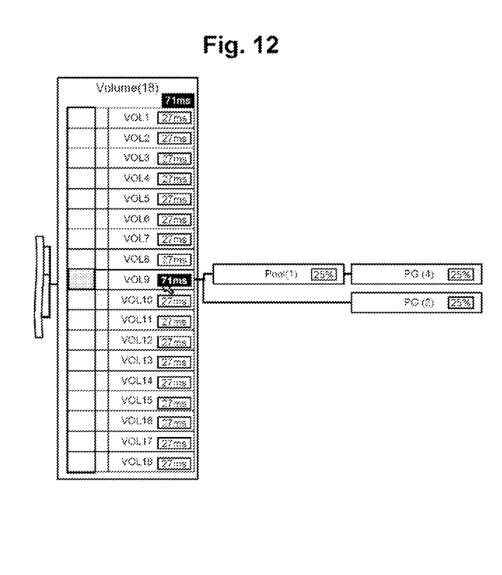

A portion (or all) the rules for the resource box may be applied to the component box (typically, the component type box). For example, information based on the performance 305 of a component belonging to this component type may be rendered in the component type box as component summary information. A component type box may be magnified vertically in response to a magnify operation (or specify operation) with respect to the component type box, and component boxes (and a capacity box) for the plurality of components maybe rendered inside the magnified component type box. According to the example in FIG. 12, a magnify operation (or a specify operation) is performed with respect to the component type box “Volume” 701B in the display screen 400 of either FIG. 10 or FIG. 11, and a plurality of component boxes 702A through 702R corresponding to a plurality of logical volumes associated with the leaf reference “APP1” is rendered inside the magnified box 701B. A capacity box 752 having a height corresponding to the height of the component boxes 702A through 702R is also rendered inside the magnified box 701B. The component boxes 702A through 702R and the capacity box 752 may also be rendered in the component type box 701B right from the start.

In FIGS. 10 through 12, the performance 305 of the port may be the data transfer rate of the port, the performance 305 of the MPB may be the utilization rate of the MP in the MPB, the performance 305 of the cache memory may be the cache memory utilization rate (the ratio of the total amount of dirty data (data still not stored in the PB) to the capacity of the cache memory), the performance 305 of the logical volume may be the response time of the logical volume, and the performances 305 of the pool and the PG may be the ratio of the used capacity to the capacities of the pool and PG. The values for these criteria may be managed in the component table 544, or may be managed in different information.

The following explanations can be given on the basis of the above explanation.

(A) Display Rule

(a1) In line with changing (magnifying or shrinking) the zoom level of an operation-target resource box, the management server program 541 is configured to also change (magnify or shrink) the zoom level of the resource box of another resource that shares the parent resource in common with the operation-target resource. The management server program 541 may be configured to make the zoom level of the resource box of the other resource the same as the zoom level of the operation-target resource box, and may be configured to lower the change rate of the zoom level the farther away the resource box is from the location where the operation-target resource box is arranged. The zoom level of a resource box of another resource that shares the parent resource in common with the operation-target resource does not have to be changed when the zoom level of the operation-target resource box is changed. Furthermore, the maximum level of the zoom level of the resource box of the other resource that shares the parent resource in common with the operation-target resource may be less than the prescribed level at which the resource box is rendered therewithin.

(a2) When magnifying an operation-target resource box, the management server program 541 is configured to also magnify the resource box of the higher-level resource of the operation-target resource (the parent resource of the target resource, and the parent resource of the parent resource and so forth). When the resource box of the higher-level resource of the operation-target resource is magnified, the resource box of a resource of the same hierarchical level as the higher-level resource may be magnified as well.

(a3) Control may be exercised so that the zoom levels of resource boxes of a plurality of resources sharing a parent resource in common are always the same. Or, the effect of a change in the zoom level of the operation-target resource may be smaller the farther away the resource box is from the operation-target resource box.

(a4) The height of the capacity box corresponds to (for example, is the same height as) the height of the element box group corresponding to this capacity box. The capacity box is vertically long.

(a5) The capacity box may be partitioned into a plurality of areas respectively corresponding to a plurality of elements (for example, the resources in FIGS. 5 and 7, and the components in FIG. 12). An object (for example, a line) is rendered for connected an area in the capacity box to the element box corresponding to this area. The height of the area corresponding to an element maybe the height corresponding to the ratio of the capacity of this element to the capacity of the parent element (for example, the component type “Volume” in FIG. 12) of this element (for example, “VOL9” in FIG. 12). The capacity box has capacity as a criterion, but a box conforming to a different criterion (for example, response time, I/O command frequency, or the like) may be displayed in place of the capacity box. Furthermore, the display mode of an area inside the capacity box of a resource is the display mode conforming to the response time status of the resource corresponding to this area, but in place thereof, the display mode may conform to the status corresponding to the actual utilization ratio of the capacity 204 allocated to the resource corresponding to this area. For example, in a case where the capacity utilization ratio of the resource is equal to or larger than 80 percent of the capacity 204 of this resource, the display mode for the area corresponding to the resource may be the warning mode. The capacity utilization ratio of a resource may be managed using the resource table 543.

(a6) As a rule, the component box is not a nested structure like the resource box, and a plurality of component boxes are lined up in a direction orthogonal to the array direction (magnify/shrink direction) of the resource boxes, that is, in the horizontal direction. An object (for example, a line) showing the relationship between components is rendered.

(a7) Component type boxes of a plurality of different types (hierarchical levels) belonging to a prescribed group is lined up in a direction parallel to the array direction of the resource box (that is, in the vertical direction).

(a8) Summary information (for example, capacity, response time, and the like) related to a resource corresponding to a resource box is rendered in at least the resource box from among the resource box and component box.

(B) When a magnify indication conforming to a magnify operation with respect to a resource (resource box) has been received:

(b1) The management server program 541 is configured to determine on the basis of the resource table 543 whether or not the resource being targeted for the magnify operation is a leaf resource.

(b2) When the result of the determination in (b1) is true, the management server program 541 is configured not to magnify the magnify operation-target resource box (not to change the zoom level).

(b3) When the result of the determination in (b1) is false, the management server program 541 is configured to determine on the basis of the resource table 543 whether or not the post-change zoom level will reach a prescribed level when the magnify operation-target resource box is magnified in accordance with the manipulated variable of the magnify operation (when the zoom level is raised).

(b4) When the result of the determination in (b3) is true, the management server program 541 is configured to magnify the magnify operation-target resource box in accordance with the manipulated variable of the magnify operation, and, in addition, to render inside the magnified resource box a resource box for the resource having the magnify operation-target resource as the parent resource. The management server program 541 is configured to render, inside the magnified resource box, a capacity box related to a resource group (one or more resources) on one side (for example, immediately to the left) of a resource box group for the resource group having the magnify operation-target resource as the parent resource.

(b5) When the result of the determination in (b3) is false, the management server program 541 is configured to magnify the magnify operation-target resource box in accordance with the manipulated variable of the magnify operation without displaying the resource box of the child resource therewithin.

(b6) In a case where the magnify operation target is not the resource box 602B within which the resource box 603A is rendered, but another resource box (for example 602A) of the same hierarchical level, the management server program 541 may be configured to hide (for example, delete) the resource box 603A in the resource box 602B, and, in addition, may be configured to magnify the resource box 602A for which the magnify operation was performed. When the zoom level of the resource box 602A has reached the prescribed level at this time, a resource object of the resource, which has the resource “Finance” corresponding to the resource box 602A as the parent resource, is rendered in the resource box 602A.

(C) When a shrink indication conforming to a shrink operation for a resource (resource box) has been received:

(c1) The management server program 541 is configured to determine whether or not a resource box or the like of a resource having the shrink operation-target resource as the parent resource is displayed inside the shrink operation-target resource box. Specifically, for example, the management server program 541 may be configured to determine on the basis of the resource table 543 whether or not the zoom level of the shrink operation-target resource box is the prescribed level. This is because when the zoom level is the prescribed level, a resource box is displayed on the inside of the shrink operation-target resource box.

(c2) When the result of the determination in (c1) is true, the management server program 541 is configured to hide (deletes) the resource box in the shrink operation-target resource box. At this time, the management server program 541 need not shrink the shrink operation-target resource box. The management server program 541 does not have to shrink the resource box of the resource that shares the parent resource in common with the shrink operation-target resource.

(c3) When the result of the determination in (c1) is false, the management server program 541 is configured to shrink the shrink operation-target resource box, and, in addition, to shrink the resource box of the other resource that shares the parent resource in common with the shrink operation-target resource.

(D) When a specify indication conforming to a specify operation with respect to a leaf resource (leaf resource box) has been received:

(d1) The management server program 541 is configured to identify from the component table 544 a plurality of components associated with the specify operation-target leaf resource, and to horizontally line up a plurality of component boxes corresponding to the identified plurality of components. An object (for example, a line) connecting the highest level box of the horizontally arranged plurality of component boxes to the resource box corresponding to the specify operation-target leaf resource is rendered.

(d2) Component boxes of different types (hierarchical levels) belonging to a prescribed group are lined up vertically.

(E) A component box (component type box) may be either magnified or shrunk like a resource box. The following are considered specific examples.

(e1) When an indication for a specify operation (or a magnify operation) with respect to a component (component box) has been received:

(e11) The management server program 541 is configured to determine whether or not the operation-target component box is a component type box.

(e12) When the result of the determination in (e11) is true, the management server program 541 is configured to magnify the operation-target component box, and to render a component box belonging to the operation-target type (and the leaf resource to which the operation-target component box is associated) inside the magnified component box.

(e2) When an indication for a specify operation (or a shrink operation) with respect to a component (component box) has been received:

(e21) The management server program 541 is configured to determine whether or not the operation-target component box is a component type box within which a component box has been rendered.

(e22) When the result of the determination in (e21) is true, the management server program 541 is configured to delete the component box from the operation-target component box, and to shrink the operation-target component box.

(F) A box for a child component (for example, a component belonging to the component type) of the component corresponding to a component box (component type box) may be rendered in the box at the time point of the initial rendering.

According to the management system described hereinabove, the following features can be expected.

(*) In a computer system having a host 553 and a storage system 551 like the computer system 100, the number of hosts 553 is normally significantly larger than the number of storage systems 551. It is conceivable that the hierarchical relationships on the resource side, which is the host side, will tend to become deeper in accordance with perspectives such as region, company, department, and/or organization. According to the management system described hereinabove, resource boxes constitute a nesting structure so as to accommodate the hierarchical relationships of the resources, and the resource boxes of lower-level resources may be displayed or hidden in accordance with either magnifying or shrinking the resource box. This makes it easier for the user to get an overview of the system as a whole while searching for a desired resource and ascertaining the hierarchical relationships of desired resources, and makes the operations for doing so intuitively easy to understand.

(*) Furthermore, a resource box for a child resource is not rendered inside a resource box other than the operation-target resource box, and a resource box for a child resource is rendered therewithin when the zoom level of the resource box of the operation-target resource has reached a prescribed level. That is, a child resource is not rendered in a resource other than the desired resource, thereby making it easier to ascertain the hierarchical relationships of the desired resource.

(*) A capacity box is rendered inside the operation-target resource box for which the zoom level has reached the prescribed level, and the capacity box is partitioned into heights corresponding to the respective capacities of a plurality of child resources. This makes it easier for the user to ascertain the breakdown of the overall capacity of the desired resource (the extent to which the resource is being used by which other resources). The user is also able to ascertain the capacity status of the resource corresponding to this area from the display mode of an area inside the capacity box.

(*) Summary information for a resource corresponding to a resource box is rendered inside this resource box. This makes it possible for the user to either magnify or shrink the resource box of the desired resource while taking in a summary of the desired resource. The summary information may be information conforming to another criterion either in place of or in addition to the capacity and the response time.

(*) Normally, the shrink operation is considered to be an operation that is performed when the user wishes to see straightforward information, and in this embodiment, in a case where a resource box and a capacity box have been displayed inside a resource box, the resource box and capacity box are collectively hidden (deleted) when a shrink operation is performed. Thus, the user can simply and quickly switch his frame of reference from a specific resource to a broader view.

(*) A plurality of elements of the computer system is divided into a plurality of resources, which is the higher-level side, and a plurality of components, which is the lower-level side. For resources, GUI objects are lined up, and magnifying and shrinking are performed in the vertical direction, and for components, GUI objects are lined up horizontally. Since GUI objects are developed two-dimensionally (both vertically and horizontally), the end-to-end (from one end to the other end) relationship is easy to ascertain even when the hierarchical relationships of the elements in the computer system are deep.

(*) An element box on the host side is magnified, shrunk, and arrayed vertically, and an element on the storage system side is arrayed horizontally. On the host side, the user can identify elements while getting the overview, and on the storage system side, can change his perspective and perform analysis will cognizant of the configuration of the data flow (the data path).

(*) Component boxes of different types, the relationships between which are not stressed in a data flow analysis, are lined up vertically. This makes it possible to prevent the array of component boxes along the horizontal direction from becoming too long even when the hierarchical relationships of the components are deep. That is, decreases in visibility can be alleviated.

(*) It is considered preferable to develop information vertically when looking at large volumes of information while getting an overview of the information, and to develop information horizontally when deciding on a single target and looking at relationships with respect to this target. In this embodiment, vertical display control is performed in accordance with a magnify operation and shrink operation, and horizontal display control is performed in accordance with a specify operation. Thus, the user can expect to carry out a desired analysis and to find targeted information using intuitive operations.

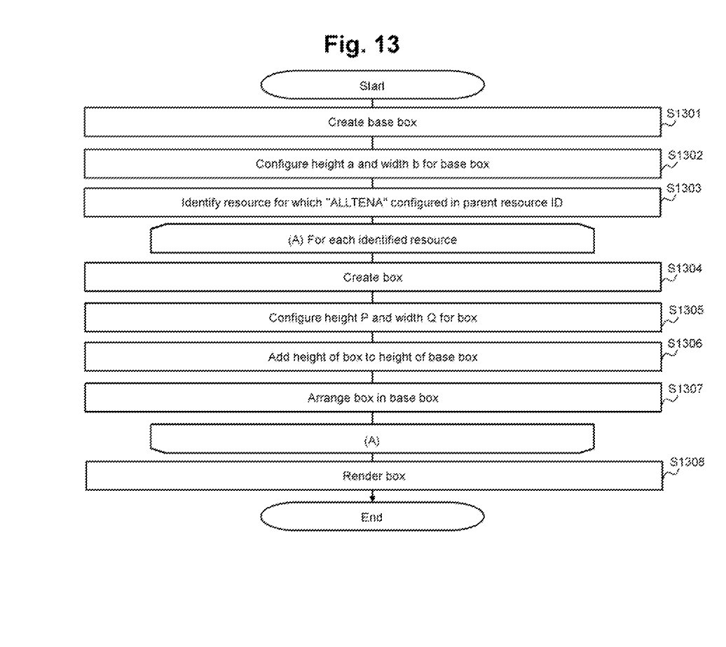

The processing performed by the management server program 541 will be explained in detail below while referring to FIGS. 13 through 24. In the explanations of FIGS. 13 through 24, box creation is the writing anew of the box-related information into memory, box arrangement is the positioning (deciding the coordinates) of the box, and box rendering is the rendering of the box in the layout area. When the location of a rendered box overlaps with the display range in the layout area, box rendering may correspond to the actual display of the box. In the explanations of FIGS. 13 through 24, the management server program 541 will be referred to simply as “program 541”.

FIG. 13 shows the flow of processing for the initial rendering of a box. An initial box rendering process is the process for rendering a resource box for the first time.

The program 541 is configured to create a base box (S1301). The base box is the root resource box, specifically, the box 600 referred to in FIG. 4. The program 541 is configured to configure the base box to height=P, width=Q (S1302). Then, the program 541 is configured to identify a resource having “ALLTENA” as the parent resource ID 203 (S1303). S1304 through S1307 below are performed for each identified resource. In the next paragraph, one of the resources identified in S1303 will be given as an example, and this resource will be referred to as the “target resource”.

The program 541 is configured to create a target resource box (S1304), and to configure the target resource box to height=P, width=Q (S1305). In line with this, the program 541 is configured to add the value P configured in S1305 to the height=P of the base box (S1306). A margin of a prescribed size may be added to both the height and width of the target resource box as the height and width of a resource box (called the resource box here) enclosing the target resource box.

The program 541 is configured to arrange the target resource box in the base box (S1307).

The program 541 is configured to render the base box and the resource box so that each constitutes the configured height and width (S1308).

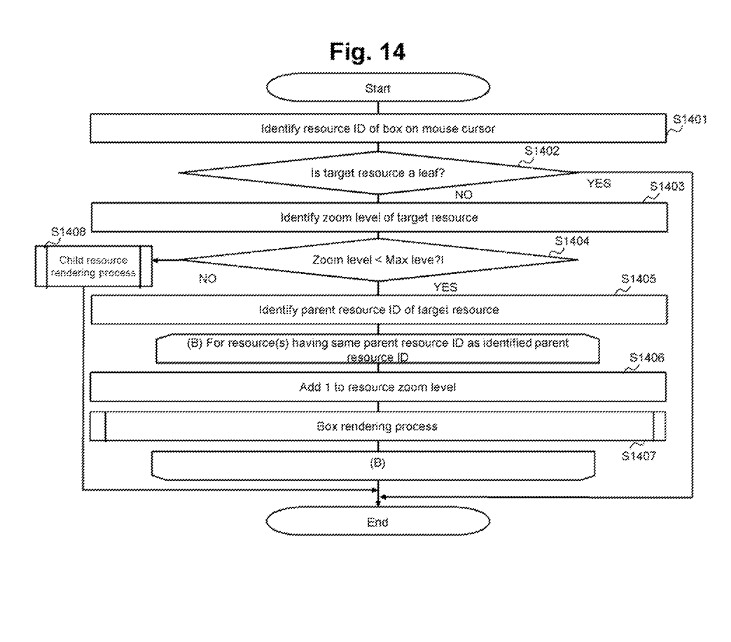

FIG. 14 shows the flow of a magnify process. The magnify process is performed when the program 541 has received a magnify indication conforming to a magnify operation.

The program 541 is configured to identify the resource ID of the operation-target resource (resource corresponding to the box that the mouse cursor is over (S1401). The program 541 is configured to determine whether or not this resource is a leaf resource (S1402). When the result of the determination in S1402 is true (S1402: YES), the magnify process ends.

When the result of the determination in S1402 is false (S1402: NO), the program 541 is configured to identify the zoom level 206 of the operation-target resource (S1403). The program 541 is configured to determine whether or not the zoom level 206 is less than a maximum level (S1404). When the result of the determination in S1404 is false (S1404: NO), a child resource rendering process is performed (S1408).

When the result of the determination in S1404 is true (S1404: YES), the program 541 is configured to identify the parent resource ID 203 of the operation-target resource (S1405). S1406 and S1407 below are performed for other resources having the identified parent resource ID 203 as the parent resource ID 203. In the next paragraph, one of the resources identified in S1405 will be given as an example, and this resource will be referred to as the “target resource”.

The program 541 is configured to add 1 to the zoom level 206 of the target resource (S1406), and to perform a box rendering process (S1407).

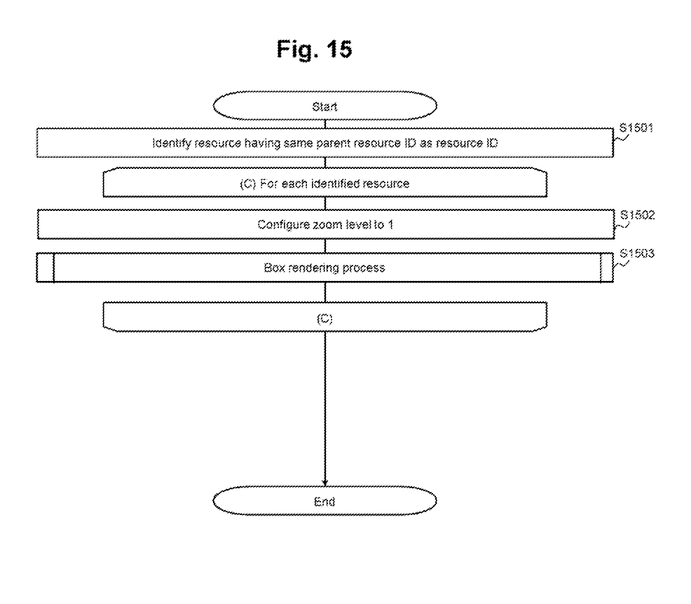

FIG. 15 shows the flow of a child resource rendering process.

The program 541 is configured to identify each resource having the resource ID of the operation-target resource as the parent resource ID 203 (S1501). S1502 and S1503 below are performed for the identified resources. In the next paragraph, one of the resources identified in S1501 will be given as an example, and this resource will be referred as the “target resource”.

The program 541 is configured to add 1 to the zoom level 206 of the target resource (S1502), and to perform a box rendering process (S1503).

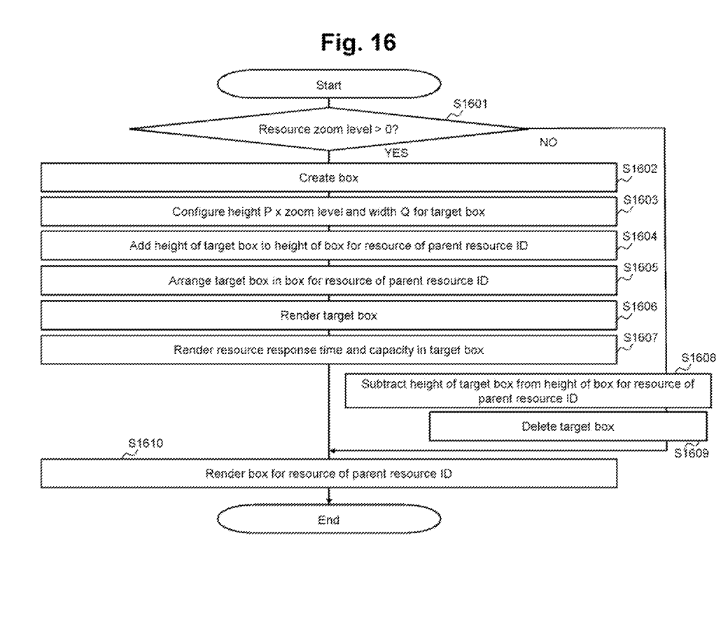

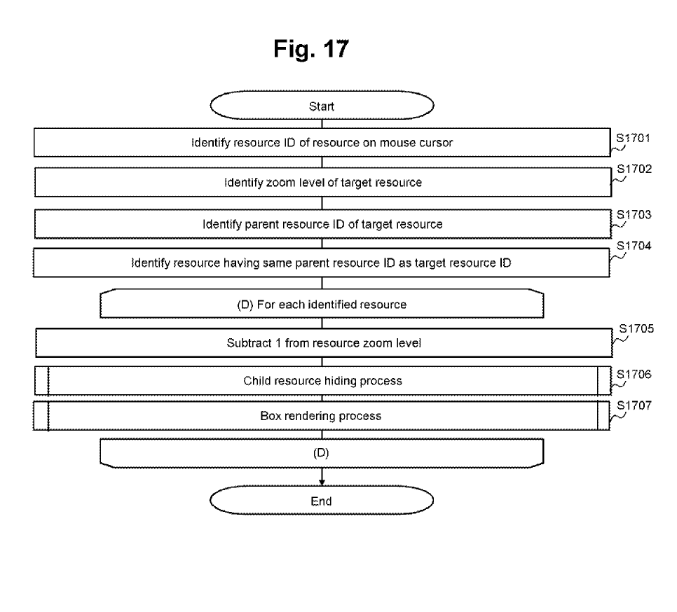

FIG. 16 shows the flow of a box rendering process. This processing is S1407 of FIG. 14, S1503 of FIG. 15, and S1707 of FIG. 17, which will be described further below.

The program 541 is configured to determine whether or not the zoom level 206 of the target resource is higher than 0 (the lowest level) (S1601). In the explanation for FIG. 16, the “target resource” is the resource for which the zoom level 206 changes in the processing of FIG. 14, FIG. 5, or FIG. 17.

When the determination result of S1601 is false (S1601: NO), the program 541 is configured to subtract the height of the target resource box from the height of the box of the parent resource of the target resource (S1608), and to delete the target resource box from the layout area (S1609). The program 541 is configured to render the box of the parent resource of the target resource (S1610).

When the determination result of S1601 is true (S1601: YES), the program 541 is configured to create a target resource box (S1602), and to configure height=P×target box zoom level 206, width=Q for the target box (S1603). The program 541 is configured to add the height of the target resource box to the height of the box of the parent resource of the target resource (S1604), and to arrange the target resource box in this parent resource box (S1605). The program 541 is configured to render the target resource box (S1606), to render the response time 205 and the capacity 204 of the target resource in the target resource box (S1607), and, in addition, to render a box for the parent resource of the target resource (S1610).

FIG. 17 shows the flow of a shrink process. The shrink process is performed when the program 541 has received a shrink indication conforming to a shrink operation. In this shrink process, a resource box with a child resource box rendered therewithin is the target of the shrink operation.

The program 541 is configured to identify the resource ID of the operation-target resource (resource corresponding to the box that the mouse cursor is over) (S1701). The program 541 is configured to identify the zoom level 206 of the operation-target resource (S1702), and, in addition, to identify the parent resource ID 203 of the operation-target resource (S1703). The program 541 is configured to also identify a resource having the same parent resource ID 203 as the identified parent resource ID 203 (S1704). S1706 and S1707 below are performed for the identified resources (and the operation-target resource). In the next paragraph, one of the resources identified in S1704 (and the operation-target resource) will be given as an example, and this resource will be referred to as the “target resource”.

The program 541 is configured to subtract 1 from the target resource zoom level (S1705), to perform a child resource hide process (S1706), and, in addition, to perform a box rendering process (S1707).

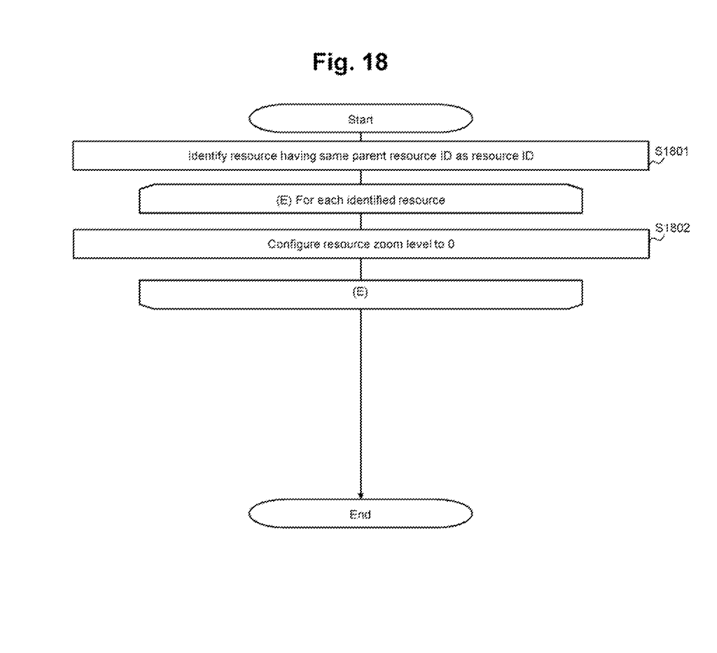

FIG. 18 shows the flow of processing for hiding a child resource.

The program 541 is configured to identify resources having the resource ID of the target resource as the parent resource ID 203 (S1801). S1802 below is performed for the identified resources. In the following paragraph, one of the resources identified in S1801 will be given as an example, and this resource will be referred to as the “target resource”.

The program 541 is configured to configure the zoom level 206 of the target resource to 0 (S1802). That is, the target resource box is hidden (deleted).

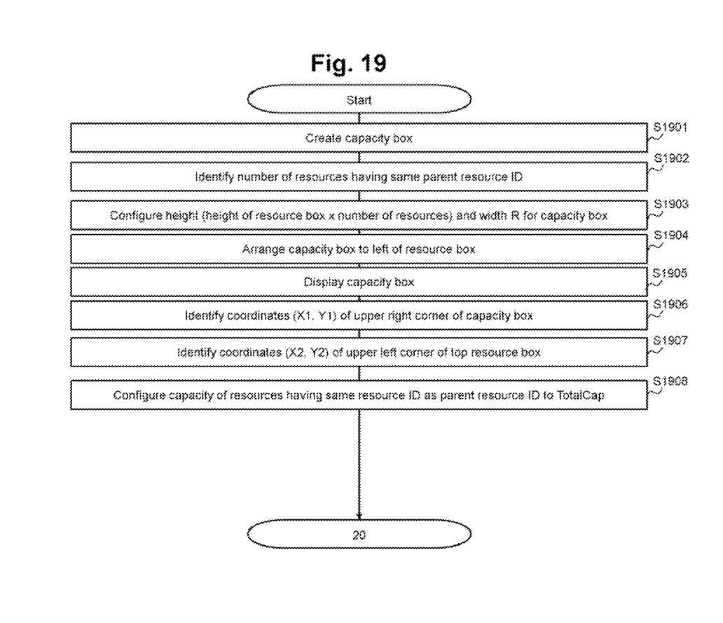

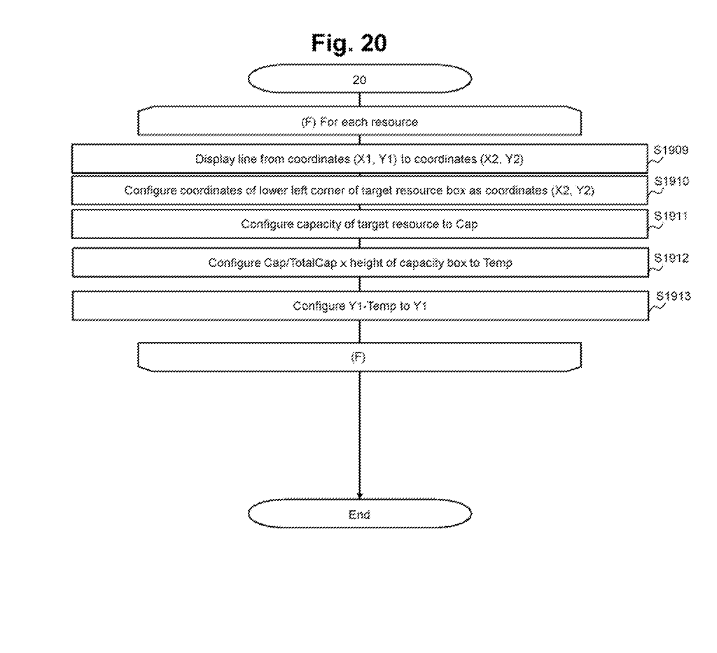

FIGS. 19 and 20 show the flow of processing for rendering a capacity box.

The program 541 is configured to create a capacity box (S1901), and to identify the number of resources (“child resources” in the explanations of FIGS. 19 and 20) having the resource of the box enclosing this capacity box as the parent resource (S1902). The program 541 is configured to configure height=(height of child resource box×number identified in S1902) and width=R for the capacity box (S1903). The program 541 is configured to arrange the capacity box to the left of the child resource box (S1904), and to render the capacity box (S1905). The program 541 is configured to identify the coordinates (X1, Y1) of the upper right corner of the capacity box (S1906), and, in addition, to identify the coordinates (X2, Y2) of the upper left corner of the topmost child resource box (S1907). The program 541 is configured to configure the capacity of the parent resource (the resource having the same resource ID 202 as the parent resource ID 203 of the child resource) as TotalCap (S1908).

S1909 through S1913 below are performed for the child resources in sequence from the child resource box displayed at the very top. In the next paragraph, one child resource will be given as an example, and this child resource will be referred to as the “target child resource”.

The program 541 is configured to render a line from the coordinates (X1, Y1) to the coordinates (X2, Y2) of the upper left corner of the target child resource (S1909). Next, the program 541 is configured to configure the coordinates of the lower left corner of the target child resource (the coordinates of the upper left corner of the child resource one therebelow) to the coordinates (X2, Y2) (S1910). The program 541 is configured to configure the capacity 204 of the target child resource as Cap (S1911). The program 541 is configured to configure (Cap/TotalCap)×(height of capacity box) as Temp (S1912). The program 541 is configured to configure Y1=Y1−Temp (S1913).

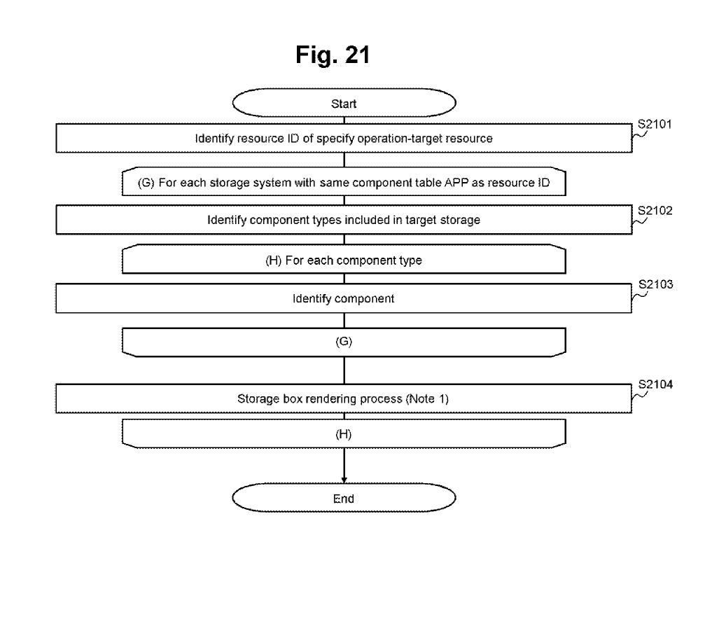

FIG. 21 shows the flow of processing for developing a leaf resource component. This processing is performed when a specify operation (for example, a mouse click) has been performed while the mouse cursor was over a leaf resource. In this processing, a component box is rendered beforehand in a component type box.

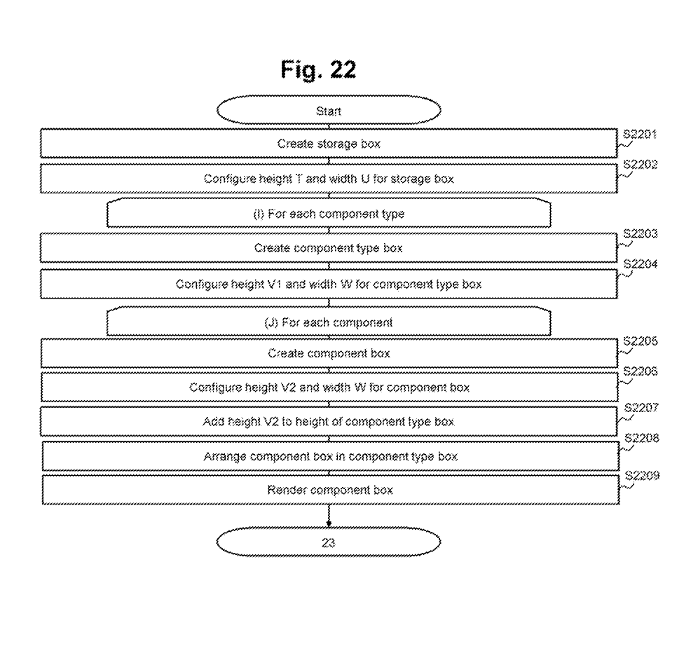

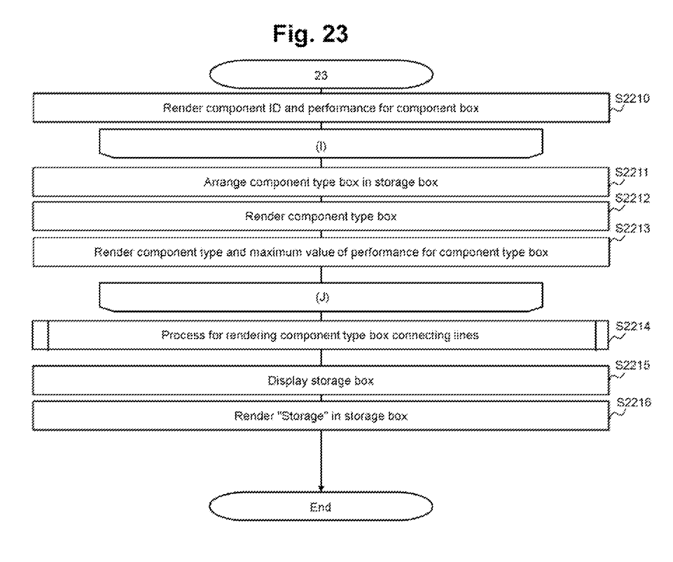

The program 541 is configured to identify the resource ID 202 of the specify operation-target resource (S2101). S2102 through S2104 below are performed for the storage systems comprising components associated with the same APP ID 301 as that of the identified resource ID 202. In the next paragraph, one storage system will be given as an example in the explanations for FIGS. 22 and 23, and this storage system will be referred to as the “target storage”.

The program 541 is configured to identify a component type 303 associated with the target storage system (S2102). S2103 below is performed for the identified component types. In this paragraph, one component type will be given as an example, and this component type will be referred to as the “target component type”. The program 541 is configured to identify the component (component ID 304) associated with the target component type 203. The program 541 is configured to perform a storage box rendering process (S2014).

FIGS. 22 and 23 show the flow of processing for rendering a storage box.

The program 541 is configured to create a storage box (a GUI object representing the target storage) (S2201), and to configure height=T and width=U for this storage box (S2202). S2203 through S2213 are performed for the component types associated with the target storage. In the next paragraph, one component type will be given as an example, and this component type will be referred to as the “target component type”.

The program 541 is configured to create the target component box (S2203), and to configure height=V1 and width=W for the target component box (S2204). S2205 through S2210 below are performed for the components associated with the target component type. In this paragraph, one component type will be given as an example, and this component type will be referred to as the “target component type”. The program 541 is configured to create a box for the target component (S2205), and to configure height=V2 and width=W for this box (S2206). The program 541 is configured to add V2 to the height of the box for the target component type (S2207), and to arrange the target component box in the target component type box (S2208). The program 541 is configured to render the target component box (S2209), and to render the component ID 304 and the performance 305 of the target component in the target component box (S2210). The program 541 is configured to arrange the target storage type box in the target storage box (S2211), and to render the target storage type box (S2212). The program 541 is configured to render the target component type 303 and the maximum value from among the performances 305 of the plurality of components belonging to the target component type for the target component type box (S2213).

The program 541 is configured to perform processing for rendering connecting lines to the component type box (S2214). The program 541 is configured to render the target storage box (S2215), and, in addition, to render “Storage” in the target storage box (S2216).

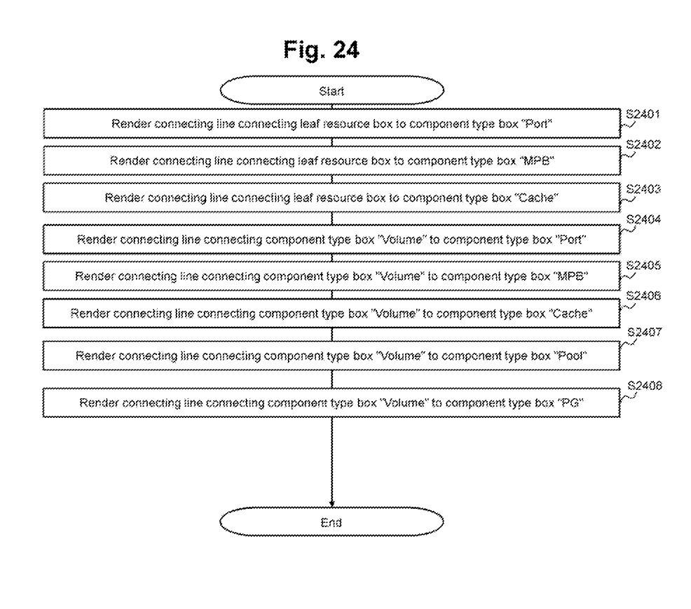

FIG. 24 shows the flow of processing for rendering connecting lines to component type boxes.

The program 541 is configured to render a connecting line between the leaf resource box and the component type box “Port” (S2401). The program 541 is configured to render a connecting line between the leaf resource box and the component type box “MPB” (S2402). The program 541 is configured to render a connecting line between the leaf resource box and the component type box “Cache” (S2403).

The program 541 is configured to render a connecting line between the component type box “Volume” and the component type box “Port” (S2404). The program 541 is configured to render a connecting line between the component type box “Volume” and the component type box “MPB” (S2405). The program 541 is configured to render a connecting line between the component type box “Volume” and the component type box “Cache” (S2406). The program 541 is configured to render a connecting line between the component type box “Volume” and the component type box “Pool” (S2407). The program 541 is configured to render a connecting line between the component type box “Volume” and the component type box “PG” (S2408).

The flow of processing for rendering connecting lines to the component type boxes may partially change in accordance with the component type associated with the leaf resource.

A favorable embodiment of the present invention has been explained hereinabove, but it goes without saying that the present invention is not limited to this embodiment, and that various changes are possible without departing from the gist thereof. For example, the computer system is not limited to a system including a host and a storage system, and may be a system having another configuration, for example, a system configured using a plurality of hosts (servers) without a storage system.

### REFERENCE SIGNS LIST

555 Management client

557 Management server

1. A management system for managing a computer system having a plurality of elements, the management system comprising:
a storage device configured to store management information defining hierarchical relationships for the plurality of elements;
an I/O (Input/Output) interface device configured to receive an indication conforming to an operation by a user, and outputting information to be displayed; and
a processor coupled to the storage device and the I/O interface device,
wherein the processor is configured to receive the user indication via the I/O interface device,
wherein the processor is configured to display, on the basis of the management information, an element object representing an element via the I/O interface device, and
wherein the processor:
(A) is configured to display each of two or more element objects respectively corresponding to two or more elements belonging to the same hierarchical level; and
(B) in a case where a magnify indication conforming to a magnify operation for a first element object from among the two or more element objects has been received:
(b1) in a case where a zoom level of the first element object does not reach a prescribed level even though the first element object is magnified in response to the magnify indication, to magnify the first element object without displaying inside the first element object an element object of a lower-level element belonging to a first element corresponding to the first element object; and
(b2) in a case where the zoom level of the first element object reaches the prescribed level when magnifying the first element object in response to the received magnify indication, to magnify the first element object, and, in addition, to display inside the first element object an element object of a lower-level element belonging to the first element.

2. A management system according to claim 1,
wherein, in the management information, a first value, which is a value for a first type criterion of an element, is associated with each of the plurality of elements,
wherein, in the (A), the processor is configured to display the two or more element objects so as to line up the two or more element objects in a first direction, and, in addition, to display a first long object, which is a long object parallel to the first direction, in a location facing the two or more element objects in a second direction that is orthogonal to the first direction,
wherein the length of the first long object is partitioned into sub-ranges respectively corresponding to the two or more element objects, and
wherein the length of each sub-range is a length corresponding to the first value of the element corresponding to this sub-range.

3. A management system according to claim 2,
wherein, in the management information, a second value, which is a value for a second type criterion of an element, is associated with each of the plurality of elements, and
wherein the processor is configured to display, inside each element object, a summary based on the second value of a lower-level element belonging to the element corresponding to this element object.

4. A management system according to claim 3,
wherein, in the (B), the processor is configured to magnify, together with the first element object, a second element object other than the first element object from among the two or more element objects, and, in addition, not to display, inside the second element object, an element object of a lower-level element of a second element corresponding to the second element object even though the zoom level of the second element object, which is not an operation target, reaches a prescribed level.

5. A management system according to claim 4,
wherein, in the (b2), the processor is configured to display, inside the first element object, element objects of two or more lower-level elements belonging to the first element so as to line up the element objects in the first direction, and, in addition, to display, inside the first element object, a second long object, which is a long object parallel to the first direction, in a location facing the element objects of the two or more lower-level elements in the second direction,
wherein the length of the second long object is partitioned into two or more sub-ranges respectively corresponding to the element objects of the two or more lower-level elements, and the length of each sub-range in the second long object is a length corresponding to the first value of the lower-level element corresponding to this sub-range.

6. A management system according to claim 5,
wherein the processor is configured to hide, in a case where a shrink indication for the first element object has been received as an indication conforming to a shrink operation by a user, the second long object and an element object of a lower-level element belonging to the first element when the second long object and the element object of the lower-level element belonging to the first element are displayed inside the first element object.

7. A management system according to claim 6,
wherein the processor is configured to hide, in a case where a shrink indication for an element object other than the first element object from among the two or more element objects has been received as a user indication conforming to a shrink operation by a user, the second long object and an element object of a lower-level element belonging to the first element, and, in addition, to shrink each of the two or more element objects when the second long object and the element object of the lower-level element belonging to the first element are displayed inside the first element object.

8. A management system according to claim 7,
wherein the two or more elements is an access-source group using a logical volume provided by a storage system, and the first value of the element is the total capacity of the logical volume provided to this element.

9. A management system according to claim 8,
wherein the plurality of elements is a plurality of resources, which is a plurality of elements on the higher-level side, and a plurality of components, which is a plurality of elements on the lower-level side, and
wherein the processor is configured to receive a specify indication conforming to a specify operation of a first terminal resource, and, on the basis of the management information, to display two or more component objects respectively corresponding to two or more components associated with the first terminal resource, in the second direction from a resource object of the first terminal resource.

10. A management system according to claim 9,
wherein, from among the two or more component objects, component objects of a plurality of different types of components belonging to a prescribed group are lined up in the first direction.

11. A management system according to claim 10,
wherein the storage system has a plurality of logical volumes and a controller for providing the plurality of logical volumes, and the controller has a port for receiving an I/O request specifying a logical volume from an access source, which is a terminal resource, a cache area for temporarily storing data to be read/written from/to the logical volume specified in the I/O request, and a storage processor, which is a processor for processing the I/O request, the component is an element of the storage system,
wherein the resource is an element related to a host coupled to the storage system, and
wherein the plurality of types of components is two or more from among the port, the cache area, and the storage processor.

12. A management system according to claim 11,
wherein the first direction is the vertical direction, and
wherein the second direction is the horizontal direction.

13. A computer program executed on a computer for managing a computer system having a plurality of elements, the computer program causing the computer to perform:
(A) displaying each of two or more element objects, which are GUI (Graphical User Interface) objects respectively corresponding to two or more elements belonging to the same hierarchical level, without displaying therewithin an element object of a lower-level element on the basis of management information defining hierarchical relationships for the plurality of elements; and
(B) when there is a magnify indication conforming to a magnify operation for a first element object from among the two or more element objects:
(b1) in a case where a zoom level of the first element object does not reach a prescribed level even though the first element object is magnified in response to the magnify indication, magnifying the first element object without displaying inside the first element object an element object of a lower-level element belonging to a first element corresponding to the first element object; and
(b2) in a case where the zoom level of the first element object reaches the prescribed level when magnifying the first element object in response to the magnify indication, magnifying the first element object, and, in addition, displaying inside the first element object an element object of a lower-level element belonging to the first element.

14. A computer program according to claim 13,
wherein, in the management information, a first value, which is a value for a first type criterion of an element, is associated with each of the plurality of elements,
wherein, in the (A), the two or more element objects are displayed so as to be lined up in a first direction, and, in addition, a first long object, which is a long object parallel to the first direction, is displayed in a location facing the two or more element objects in a second direction that is orthogonal to the first direction,
wherein the length of the first long object is partitioned into sub-ranges respectively corresponding to the two or more element objects, and
wherein the length of each sub-range is a length corresponding to the first value of the element corresponding to this sub-range.

15. A computer program according to claim 13,
wherein the plurality of elements is a plurality of resources, which is a plurality of elements on the higher-level side, and a plurality of components, which is a plurality of elements on the lower-level side, and
wherein, when there is a specify indication conforming to a specify operation of a first terminal resource, the computer program causes the computer to display, on the basis of the management information, two or more component objects respectively corresponding to two or more components associated with the first terminal resource, in the second direction from a resource object of the first terminal resource.
